(19) United States
(12) Patent Application Publication
(10) Pub. No.: US 2008/0168743 A1
(43) Pub. Date: Jul. 17, 2008

(54) FLAPPER DOOR PANEL

(76) Inventor: Edward S. Robbins, Muscle Shoals, AL (US)

Correspondence Address: INDIANAPOLIS OFFICE 27879;BRINKS HOFER GILSON & LIONE, ONE INDIANA SQUARE, SUITE 1600, INDIANAPOLIS, IN, 46204-2033, US

(21) Appl. No.: 11/959,832

(22) Filed: Dec. 19, 2007

Related U.S. Application Data
(60) Provisional application No. 60/879,894, filed on Jan. 11, 2007.
(60) Provisional application No. 60/919,642, filed on Mar. 23, 2007.

(51) Int. Cl. E06B 3/70

(52) U.S. Cl. 52/745.19; 52/456

(57) ABSTRACT

A traffic door panel is formed by an extrusion process that includes at least one pattern roll having both textured and smooth areas, the textured areas forming generally translucent or opaque areas of the traffic door panel and the smooth areas forming generally transparent areas of the traffic door panel. The textured areas can be formed to be thicker than the transparent areas. Some selected areas of the door panel can be cut out. Inserts can be bonded or welded into selected cut out areas of the door panel.

### CROSS-REFERENCE TO RELATED APPLICATIONS

The present invention is related to and claims all available benefit of provisional applications Ser. No. 60/879,894 filed Jan. 11, 2007, and Ser. No. 60/919,642 filed Mar. 23, 2007, which are hereby incorporated by reference.

### BACKGROUND OF THE INVENTION

The present invention relates to traffic doors and, more particularly, to a new and improved design and method of constructing plastic traffic doors.

Traffic doors, also referred to as impact doors, are swinging doors, typically two-way swinging doors, commonly used in industrial and commercial establishments. The doors are normally biased to a closed position and can be swung to the open position manually or by impact with material handling equipment, such as fork lift trucks, hand trucks, shopping carts, etc. Conventional commercial plastic traffic doors are used in a variety of retail operations, such as supermarkets, convenience stores, and restaurants, as well as in warehouses and manufacturing facilities.

Traffic doors are well known. For example, U.S. Pat. Nos. 3,979,872 to Gilchrist et al., 3,854,263 to Eckel, 4,397,117 to Shipp, and 5,459,972 to Eckel, all disclose typical prior art traffic doors. Traffic doors must be designed and manufactured of materials with sufficient strength and resiliency to withstand impact during opening. The prior art doors typically consist of an internal framework with two oppositely facing door face panels, and can include internal sound insulation. The manufacturing costs associated with prior art traffic doors have been high because of the impact resistance requirements and the method of assembling the doors.

The assembly of a typical prior art traffic door generally involves placing a first rectangular plastic door face panel on a supporting work table, and then adhesively or otherwise bonding to that door face panel a plurality of rectangular struts or frame members so as to form a rectangular framework. The frame members are usually made of wood or are extruded rubber or plastic parts. This series of steps includes the need to prepare the opposite sides of the frame members, and preferably also one surface of the two door face panels, for bonding of the door face panel to the frame members. Often, the doors include a window in the form of an opening that is filled with a pane of transparent material. Usually the panel is secured in place by mechanically fastened means, which may include a surrounding frame. Door-pivoting hardware, typically consisting of a lower bearing for the pivot shaft and at least a portion of a door cam assembly, is mounted to the door assembly to complete the manufacturing process

Commercially available impact doors typically have door face panels in the form of sheets of acrylonitrile butadiene styrene polymer (A.B.S.), polyethylene, or polyvinylchloride. In applications where the doors are in close proximity to food or pharmaceuticals, the panels constitute U.S.D.A. and F.D.A.-approved grades of these or other like materials. Some prior art traffic impact doors commonly are provided with bumpers and wear panels to provide increased impact resistance and longer door life. The bumpers and wear panels may be made of various materials, e.g., plastic, rubber or metal. Typically bumpers are formed of a stiff plastic (e.g., polyethylene) or a hard rubber sheet material and are surface mounted to the plastic door face panels using mechanical fasteners. Plastic bumpers can be molded in colors to match the color of the door face panel; however an exact color match may be difficult or costly to obtain.

Despite the various features and benefits of the structures of the forgoing disclosures, there remains a need for a less costly construction that could be employed particularly in situations where the need for insulation may be minimal. There also remains a need for a simpler inclusion of transparent window areas in a door of sufficient strength and resiliency to survive the impact of trucks, carts, etc.

### SUMMARY OF THE INVENTION

These several needs may be satisfied by extruding a chosen plastic between rolls having some selected areas that are smooth and other selected areas that are textured to form a sheet having transparent and opaque or translucent areas, respectively. The texturing for the translucent areas can be in the form of embossments that distort the view through the sheet, but still allow light to pass through the sheet. The sheet is then cut to form a door panel with the smooth transparent areas situated at the desired height for provide visual information concerning traffic or obstacles on an opposite side of the door. Various patterns for the transparent, translucent, and opaque areas can be achieved through the use of extrusion rolls having differing patterns for the smooth and textured areas.

One or more films can be introduced between the rolls adjacent to the extrusion process, the films having colors, tint, pigments and/or patterns that are integrated into the sheet being formed. Once formed, the sheet can be introduced to a cutting operation that can define the perimeter and other features of the door panel, including interior cut-outs. In one particular embodiment, the extruded sheet can be substantially colored and/or textured over the entire surface of the sheet, and the subsequent die-cutting operation used to cut an opening through the door panel formed from the sheet. The opening can be filled by another similarly cut sheet of clear plastic, that can be bonded, welded, or otherwise secured in the opening.

The door panel can be employed in the constructions discussed previously to avoid the need for separate mechanical fastenings and frames to define a window area. The door panel can also be used to form a single panel door by simply attaching the necessary hardware directly to the die-cut sheet. The resulting door panel is sufficiently strong yet flexible to withstand repeated impact and frictional abrasion. The resulting door panel provides can provide the requisite privacy and protection to a given area while also providing sufficient visibility to prevent mishaps to people or equipment.

Other features of the present invention and the corresponding advantages of those features will be come apparent from the following discussion of the preferred embodiments of the present invention, exemplifying the best mode of practicing the present invention, which is illustrated in the accompanying drawings. The components in the figures are not necessarily to scale, emphasis instead being placed upon illustrating the principles of the invention. Moreover, in the figures, like referenced numerals designate corresponding parts throughout the different views.

### BRIEF DESCRIPTION OF THE DRAWINGS

FIG. 1 is a schematic side elevation view of an extruding and roll forming apparatus for making sheets to be formed into door panels of the present invention.

FIG. 2 is a schematic front elevation view of a roll that can be employed in the apparatus shown in FIG. 1.

FIG. 3 is a schematic front elevation view of another roll that can be employed in the apparatus shown in FIG. 1.

FIG. 4 is a schematic side elevation view of another extruding and roll forming apparatus for making sheets to be formed into door panels of the present invention.

FIG. 5 is a schematic side elevation view of yet another extruding and roll forming apparatus for making sheets to be formed into door panels of the present invention.

FIG. 6 is a perspective view of a door panel cut from a sheet formed in accordance with the present invention.

FIG. 7 is a perspective view of a door panel as shown in FIG. 4 with mounting hardware to mount the door panel in a doorway.

FIG. 8 is a perspective view of a pair of door panels as shown in FIG. 4 with mounting hardware to mount the door panels in a doorway.

FIG. 9 is a perspective view of another pair of door panels formed in accordance with the present invention with mounting hardware to mount the door panels in a doorway.

FIG. 10 is a perspective view of still another pair of door panels formed in accordance with the present invention with mounting hardware to mount the door panels in a doorway.

FIG. 11 is a perspective view of yet another pair of door panels formed in accordance with the present invention with mounting hardware to mount the door panels in a doorway.

FIG. 12 is an exploded perspective view of another door panel formed in accordance with the present invention along with mounting hardware to mount the door panel in a doorway.

FIG. 13 is a perspective view of the opposite side of the door panel shown in FIG. 12, when assembled.

FIG. 14 is an exploded perspective view of another door panel formed in accordance with the present invention along with a cover member and mounting hardware to mount the door panel in a doorway.

FIG. 15 is a perspective view of the door panel shown in FIG. 14, when assembled.

### DESCRIPTION OF PREFERRED EMBODIMENTS

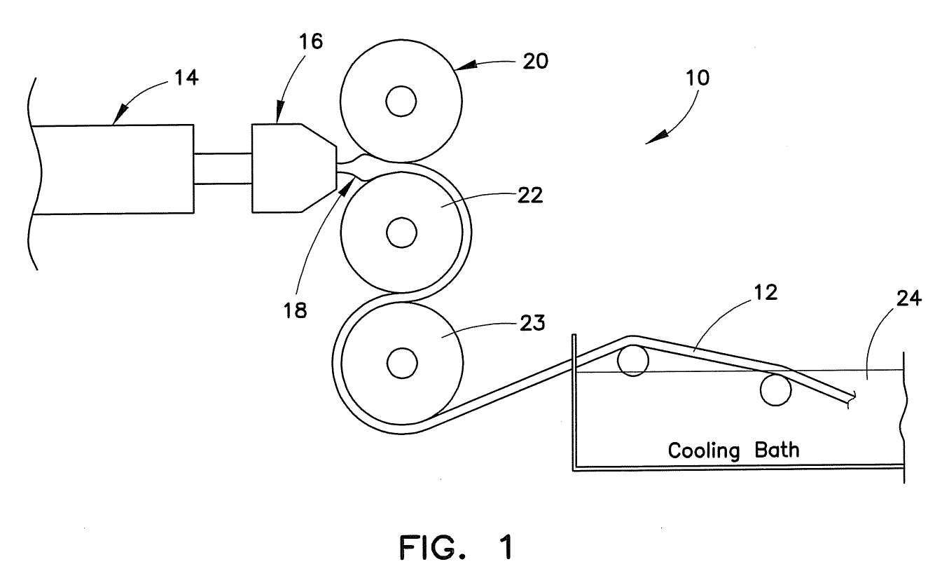

An apparatus 10 is shown schematically in FIG. 1 that can be utilized to form a continuous sheet 12 of plastic that can be used for the door panels of the present invention. The apparatus 10 includes an extruder 14 that feeds molten plastic material to a die 16, with extrudate in molten form exiting the die 16 and entering the nip region 18 between a pair of pattern rolls 20 and 22. The pattern rolls 20 and 22 can have surface features, as described below, that are impressed into the surface or surfaces of the continuous sheet 12. A take off roll 23 transfers the continuous sheet from the forming operation into a cooling bath 24 where the sheet 12 is cooled and thus solidified with the features formed by the pattern rolls 20 and 22.

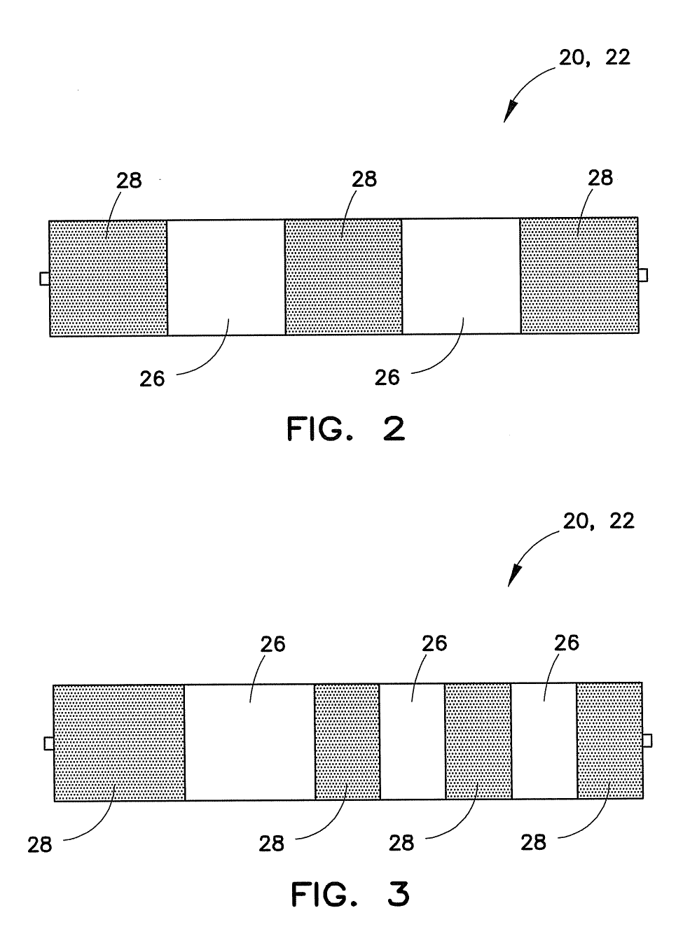

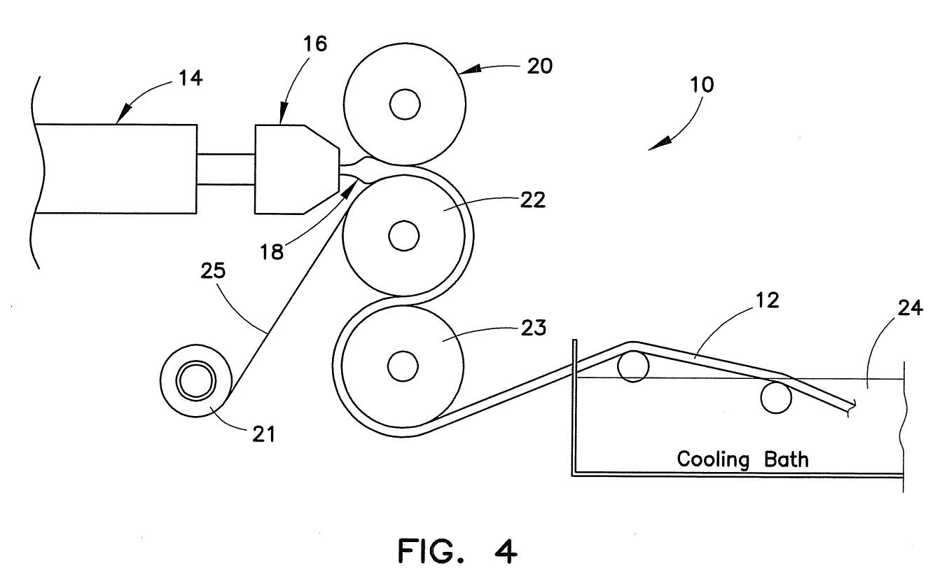

Each of the pattern rolls 20 and 22 include smooth areas 26 and textured areas 28 as shown, for example, in FIGS. 2 and 3. The specific size and arrangement of the smooth areas 26 and textured areas 28 is subject to considerable variation, and the illustrated examples shown in FIGS. 2 and 3 are not intended to exhaust the possibilities. The rolls 20 and 22 are generally cylindrical and of nearly constant diameter, however some selected regions of one or more of the rolls can be slightly smaller to achieve still further effects in the sheet 12. For example, one or more of the textured areas 28 can be of slightly smaller diameter so that the corresponding portion of the extruded sheet 12 will project out from the remainder of the surface. When formed into a door, the outwardly projecting textured areas 28 will act to protect any adjacent transparent areas from wear and abrasion.

One or more additional rolls 21 can supply a film 25 into the nip region 18. The film 25 can be formed of a similar plastic as the plastic forming the sheet 12, or can be formed of a plastic having a higher melting point so that the film 25 is dimensionally stable as it passes through the nip region 18 in direct contact with the plastic forming the sheet 12. The film 25 can also include a reinforcing element to be included in the textured areas 28. The additional rolls 21 can have any width so that the film 25 can be aligned with any selected portion of the sheet 12, or even extend over the whole width of the sheet 12. While the film 25 is shown to be entering the nip region 18 from below the die 18, it will be appreciated that the film 25 could also be introduced from above the die 18. The film 25 can be in the form of a colored or patterned film that imparts a color, hue, tint, pattern, design or other effect to at least a portion of the extruded sheet 12. The added film 25 is preferably integrally bonded to a surface of the extruded sheet 12 so that it forms a single structure with the sheet 12 when it exits from the take off roll 23.

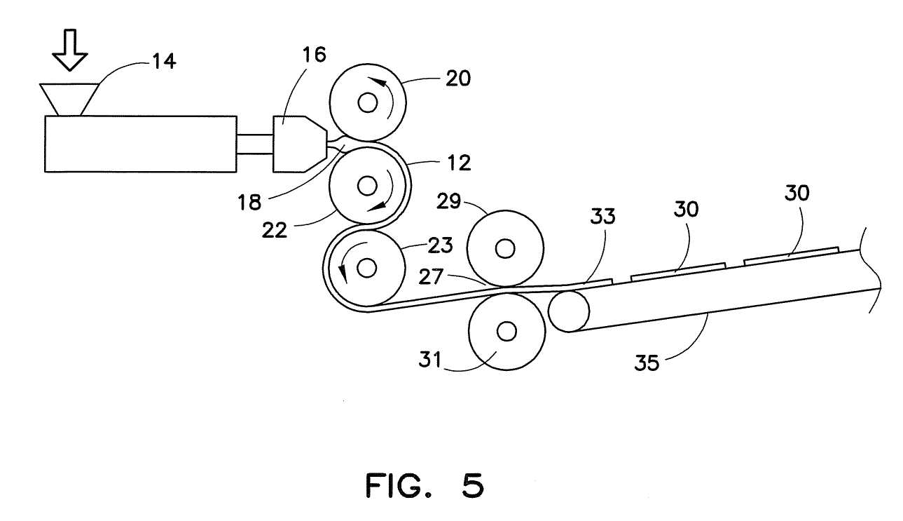

The extruded sheet 12, once cooled, can then be cut into door panels 30 of suitable dimension as shown, for example, in FIG. 5, by passing the extruded sheet 12 between the nip 27 of two die cutting rolls 29 and 31. As the die cut sheet 33 exits the nip 27, the individual door panels 30 can be separated from each other by a conveyor 35 moving at a slightly higher speed than the exiting cut sheet 33. The pattern provided on the two die cutting rolls 29 and 31 can be varied as required to provide the necessary perimeter dimensions for the door panels 30. The pattern can also provide for additional openings to receive mounting hardware, etc. Other known cutting elements can be substituted for the die cutting rolls 29 and 31.

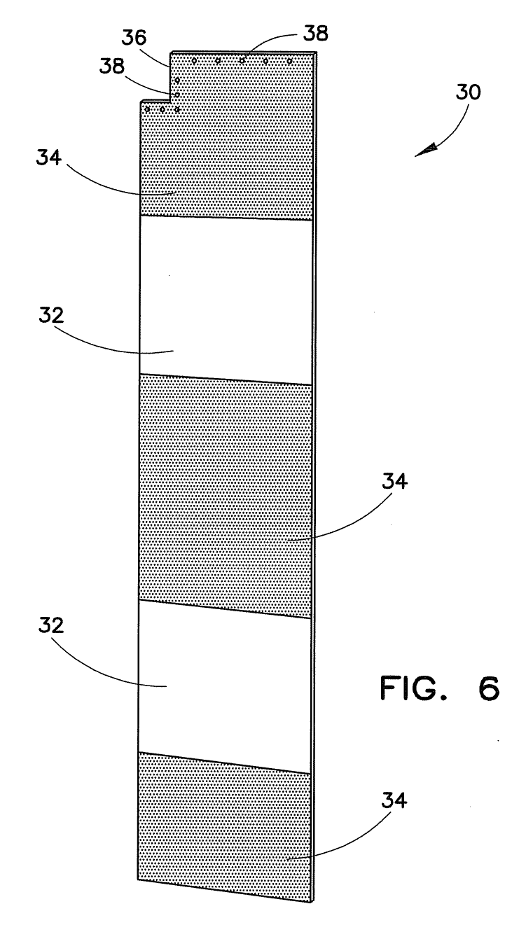

As shown in FIG. 6, the door panels 30 reflect the surface features of the rolls 20 and 22. For example, the area 32 of the door panel 30 has a smooth surface formed by the smooth area 26 of the rolls 20 and 22. If the sheet 12 if formed of a substantially transparent plastic, the smooth area 32 can form a window that permits one to see objects on the opposite side of the door panel 30. The areas 34 of the door panel 30 have a textured or roughened surface that generally renders the sheet 12 sufficiently translucent to opaque to prevent any clear viewing of objects on the opposite side of the door panel 30, but may still allow light to pass through so that shadows and bright areas may still be discernable through the door panel 30.

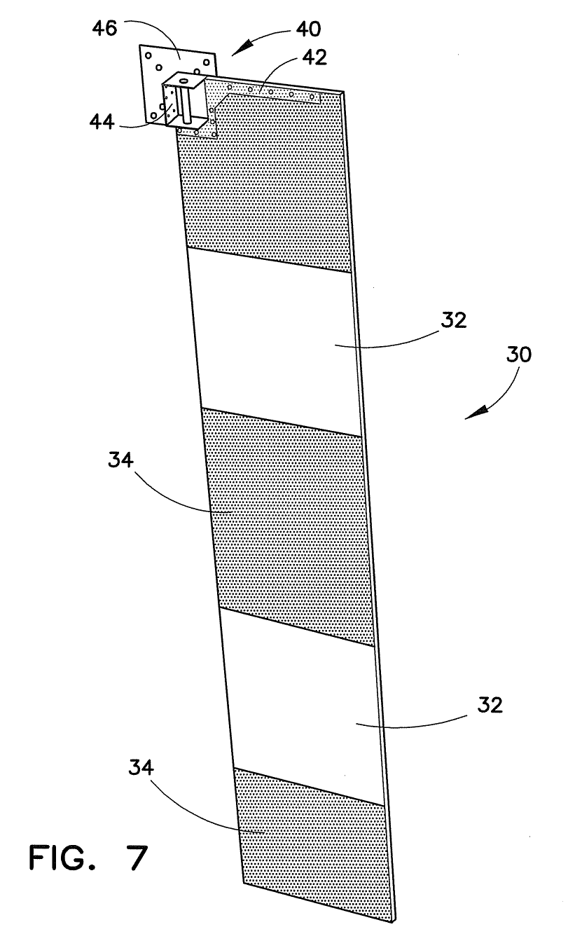

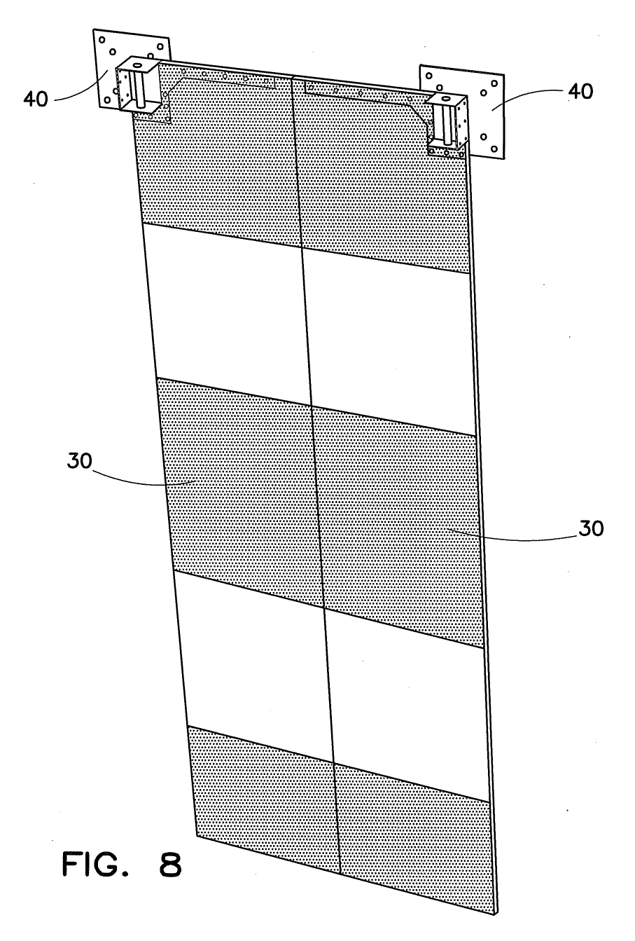

One or more edges of the sheet 12 can be cut and or punched to provide notches 36 and/or holes 38, which can be used to accept hardware 40 for mounting the door panel 30, as shown, for example in FIG. 7. The cutting and/or punching can be achieved in a die-cutting operation as shown in FIG. 5, or may be the subject of a completely separate step once the door panels 30 have been isolated from each other. The hardware 40 can include, for example, a top member 42 adapted to extend horizontally across most or all of the width of the door panel 30. A hinge member 44 can be coupled to the top member 42. The hinge member 44 can be coupled to a support member 46 that is adapted to mount the hinge member 44 to a bulkhead adjacent to a doorway. While the door panels 30 of the present invention can be used singly as shown in FIG. 7, a more typical use will be as a pair of doors 30 mounted as shown in FIG. 8 to opposite sides of a common doorway. Other mounting arrangements are, of course, also possible.

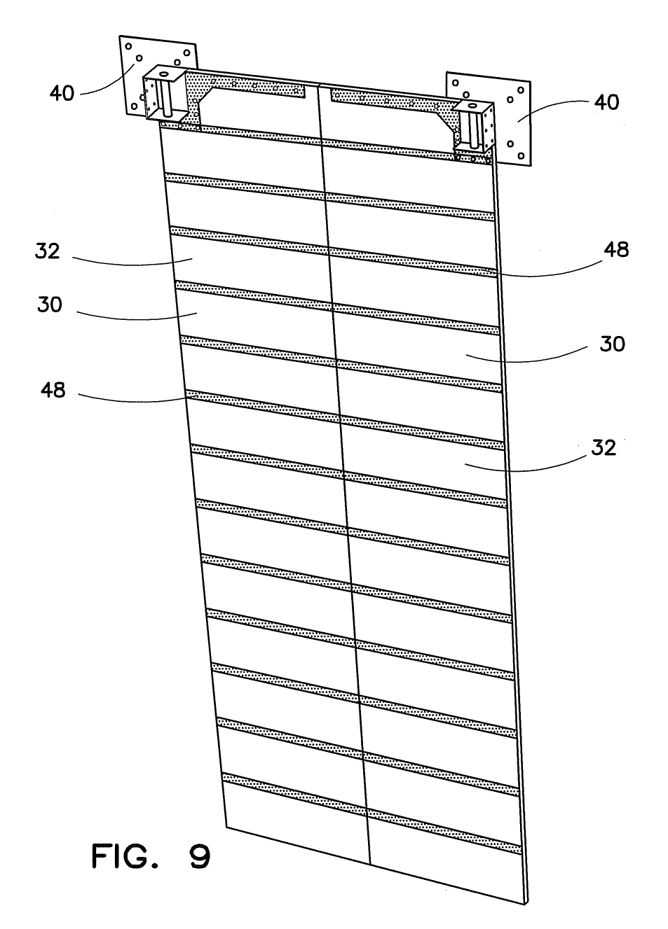

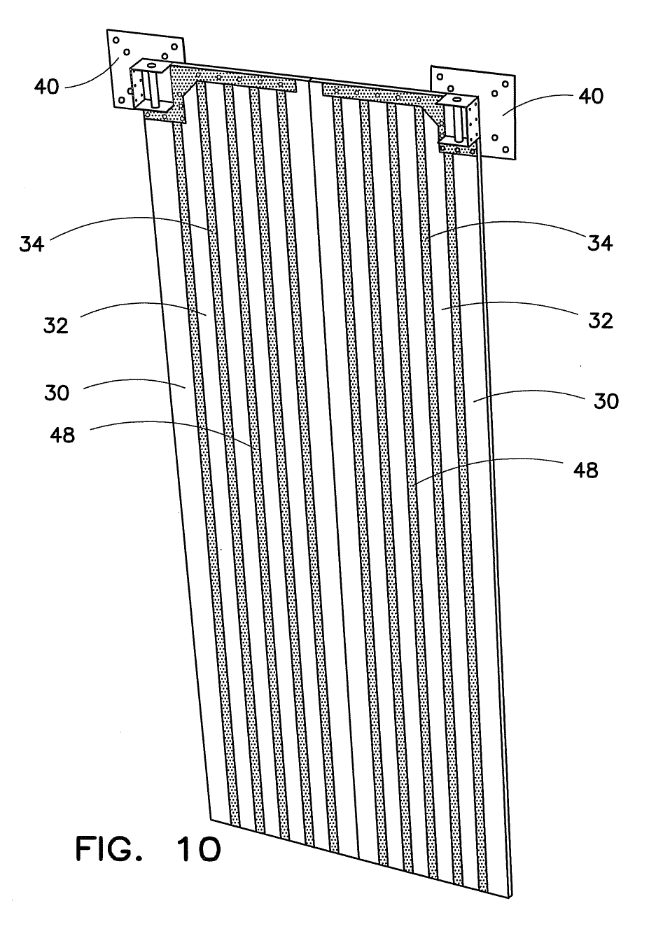

FIG. 9 shows another pair of doors 30 of the present invention wherein the translucent or opaque areas 34 take the form of horizontal stripes 48. The stripes 48 can be formed by recessed textured areas on the rolls 20 and 22 so that the stripes 48 project outward from the adjacent smooth transparent areas 32, thereby forming a protective buffer or bumper.

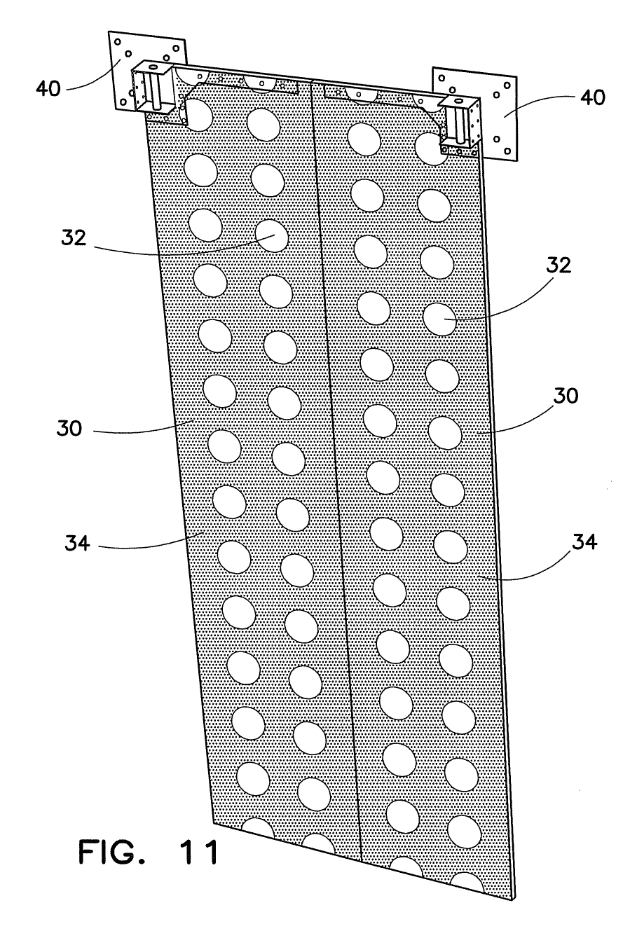

FIG. 10 is a perspective view of still another pair of door panels 30 formed in accordance with the present invention having vertically arranged rows of smooth transparent areas 32 separated by textured areas 34. The stripes 48 can be angled one direction or another rather than merely horizontal or vertical. Further, the stripes 48 can have patterned edges rather than the straight edges shown in FIGS. 9 and 10.

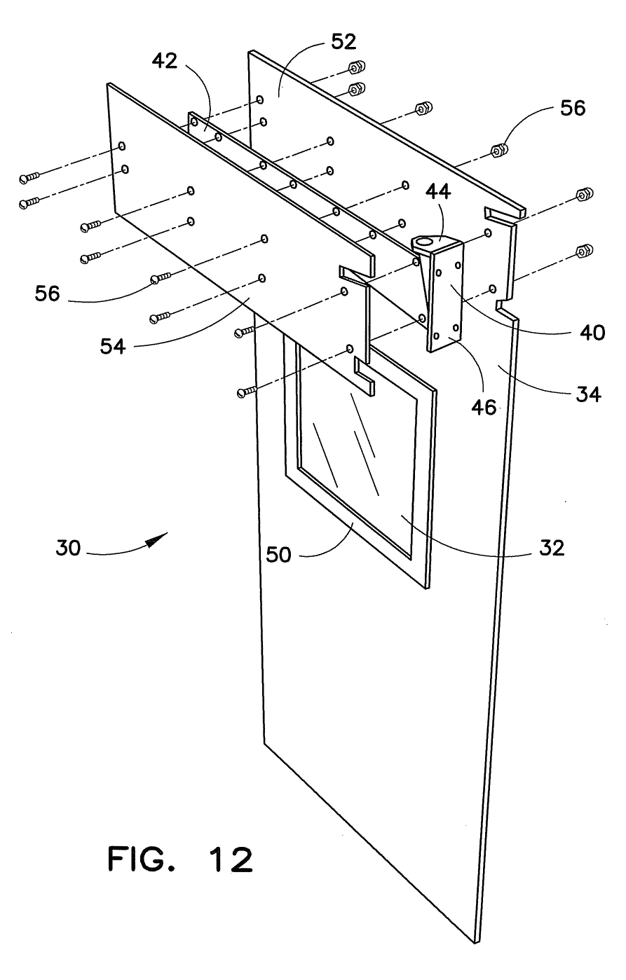

FIG. 11 is a perspective view of yet another pair of door panels 30 formed in accordance with the present invention having smooth transparent port hole areas 32 surrounded by a continuous textured area 34. The smooth transparent port hole areas 32 can be formed by merely having smooth, polished areas on the pattern rolls 20 and 22, and can be formed to be thinner than the surrounding material forming the door panel 30. While the port hole areas 32 are shown to be circular, they can have other shapes, whether fanciful or geometric in character. The port hole areas 32 can also be formed by cutting openings in the otherwise textured door areas 34, and inserting a smooth insert having a similar perimeter to the cut opening. The smooth insert and be bonded, welded, or otherwise secured in the door panel to form a single panel without the use of additional hardware.

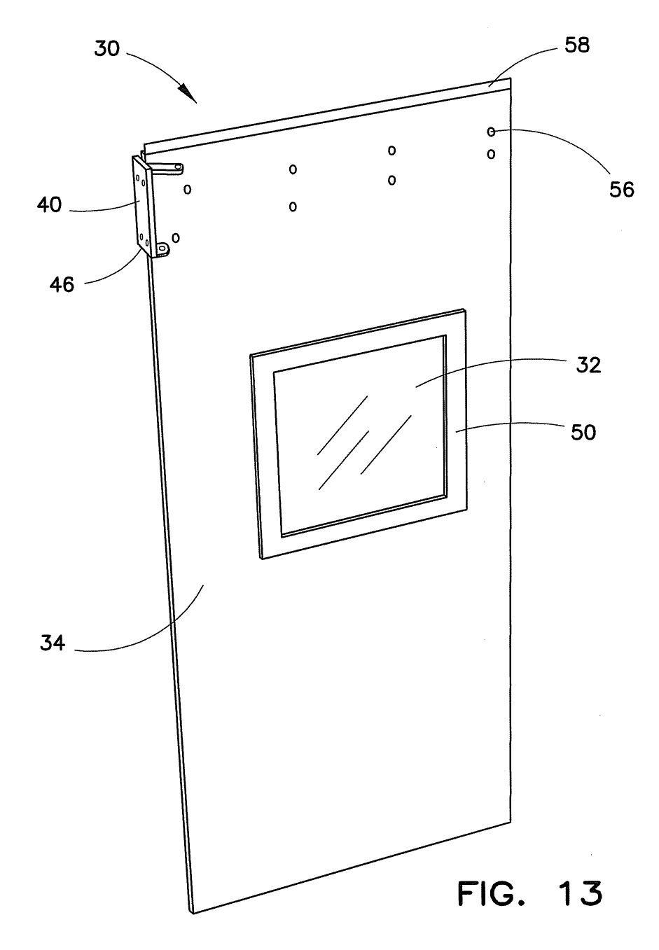

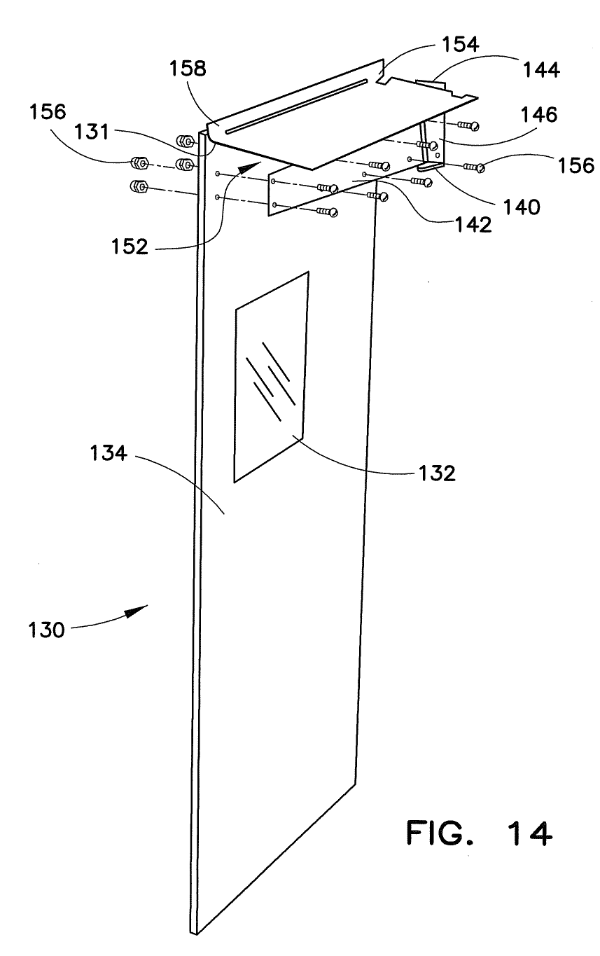

FIGS. 12 and 13 are perspective views of another door panel 30 of the present invention that includes a single transparent port hole or window area 32 surrounded by a textured, translucent or opaque area 34, the window area 32 being formed by cutting an opening in the door area 34, and inserting a smooth transparent insert having a similar perimeter to the cut opening. The insert can be glued, bonded, welded, or otherwise secured in the door panel to form a single panel without the use of additional hardware. A layer of tape, such as opaque PVC, can be bonded over the junction between the window area 32 and the surrounding opaque area 34 to visually define a frame 50, which can be situated on only one or on both sides of the door panel 30.

Supporting hardware 40 for the door panel 30 shown in FIGS. 12 and 13 can include, for example, a top member 42 adapted to extend horizontally across most or all of the width of the door panel 30. A hinge member 44 can be coupled to the top member 42. The hinge member 44 can be coupled to a support member 46 that is adapted to mount the hinge member 44 to a bulkhead adjacent to a doorway. The top member 42 can be received in a pocket 52 defined by an overlying sheet member 54, which can be textured and/or opaque, that is glued or bonded to the door panel 30 around a substantial portion of the perimeter of the overlying sheet member 54. A plurality of fasteners 56, such as screws and barrel nuts, can be provided to further secure the door panel 30 and overlying sheet member 54 to the top member 42 of the supporting hardware 40. The overlying sheet member 54 can be vertically off-set with respect to the top edge of the door panel 30 to define an air seal 58 against an overhead portion of a doorway in which the structure is mounted.

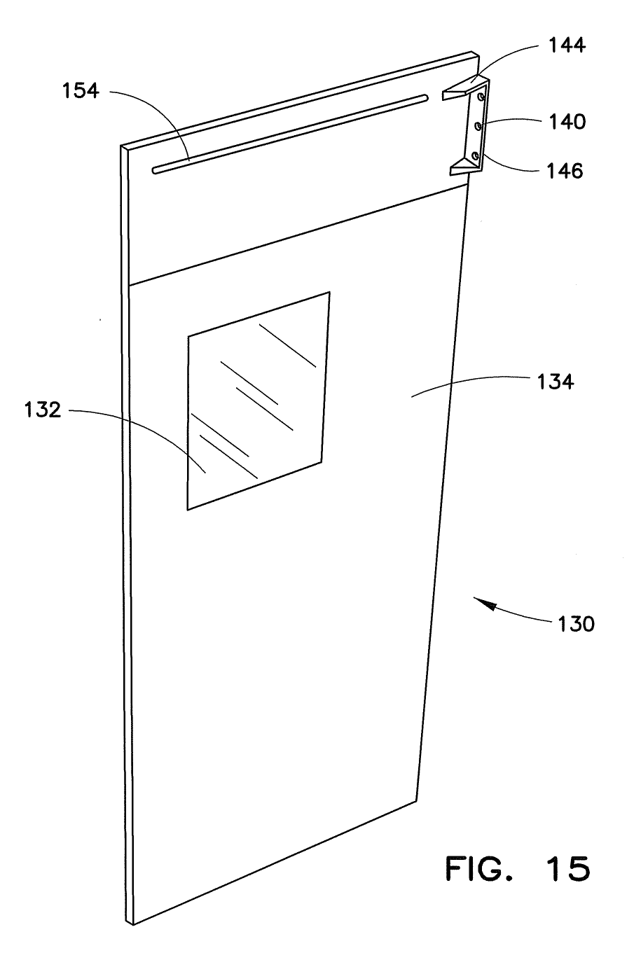

FIGS. 14 and 15 are perspective views of another door panel 130 of the present invention that includes a single transparent port hole or window area 132 surrounded by a textured, translucent or opaque area 134. The window area 132 can be formed by cutting an opening in the door area 134, and inserting a smooth transparent insert having a similar perimeter to the cut opening. The insert can be glued, bonded, welded, or otherwise secured in the door panel to form a single panel without the use of additional hardware. A layer of tape, such as opaque PVC, can be bonded over the junction between the window area 132 and the surrounding opaque area 134 to visually define a frame, which can be situated on only one or on both sides of the door panel 130.

Supporting hardware 140 for the door panel 130 shown in FIGS. 14 and 15 may include a top member 142 adapted to extend horizontally across most or all of the width of the door panel 130. A hinge member 144 can be coupled to the top member 142. The hinge member 144 can be coupled to a support member 146 that is adapted to mount the hinge member 144 to a bulkhead adjacent to a doorway. A plurality of fasteners 156, such as screws and barrel nuts, can be provided to further secure the door panel 130 to the top member 142 of the supporting hardware 140. The top member 142 can be received in a pocket 152 defined by an overlying cover member 154, which can be textured and/or opaque. The cover member 154 can be glued or bonded along a substantial portion of the top edge 131 of the door panel 130. Preferably, the upper portion of cover member 154 is welded to a substantial portion of the top edge 131 of the door panel 130. The cover member 154 generally should be sized to cover or substantially hide the top member 142 and the fasteners 156. FIG. 15 illustrates the cover member 154 that is assembled with the door panel 130 and covers the supporting hardware 140. The cover member 154, furthermore, can be vertically off-set with respect to the top edge 131 of the door panel 130 to define an air seal 158 against an overhead portion of a doorway in which the structure is mounted.

While these features have been disclosed in connection with the illustrated preferred embodiments, other embodiments of the invention will be apparent to those skilled in the art that come within the spirit of the invention as defined in the following claims.

What is claimed is:

1. A method of forming a traffic door panel comprising the steps of:
providing at least one pattern roll with selected smooth areas and selected textured areas,
extruding a chosen plastic into the nip region of a pair of rolls that includes the at least one pattern roll,
extracting from the pair of rolls a sheet of formed plastic reflecting the smooth and textured areas of the at least one pattern roll, and cutting a traffic door panel from the formed plastic sheet.

2. The method of claim 1 further comprising the step of adding mounting hardware to at least one side of the traffic door panel.

3. The method of claim 1 further comprising the steps of cutting out a window opening in the traffic door panel, inserting a clear plastic panel into the window opening, and bonding or welding the clear plastic panel to the traffic door panel.

4. The method of claim 1 further comprising the step of introducing one or more films between said pair of rolls during the extrusion step, the films having colors and/or patterns that are integrated into the sheet being formed.

5. A traffic door panel formed by the method of claim 1 or 2 or 3 or 4.

6. The traffic door panel of claim 5 wherein the smooth areas of the door panel are transparent.

7. The traffic door panel of claim 5 wherein the textured areas of the door panel project outward from the door panel surface beyond the smooth areas of the door panel.

8. The traffic door panel of claim 5 wherein the smooth areas and the textured areas form stripes.

9. The traffic door panel of claim 8 wherein the stripes are vertical.

10. The traffic door panel of claim 8 wherein the stripes are horizontal.

11. The traffic door panel of claim 5 wherein the smooth areas are in the form of port holes in a continuous textured surface.

12. The traffic door panel of claim 11 wherein the port holes are thinner than the surrounding material forming the door panel.

13. The traffic door panel of claim 5 wherein at least a portion of the door panel is colored.

14. The traffic door panel formed by the method of claim 4 wherein at least two portions of the door panel are colored different colors.

15. The traffic door panel formed by the method of claim 3 wherein the entire door panel is textured except said clear plastic panel.

16. The traffic door panel of claim 15 further comprising a layer of tape overlying a region on the perimeter of the clear plastic panel.

17. The traffic door panel formed by the method of claim 2 wherein a further layer of plastic is placed to overlie at least a portion of the mounting hardware.

18. The traffic door panel of claim 17 wherein a perimeter portion of the further layer of plastic is bonded to the traffic door panel to define a pocket receiving a portion of the mounting hardware.

19. The traffic door panel of claim 18 further comprising a plurality fasteners penetrating the traffic door panel, mounting hardware and further layer of plastic.

20. A system for manufacturing traffic door panels comprising:
an adjacent pair of rolls spaced from each other to define a nip region between the rolls, at least one of the rolls having a surface with selected smooth areas and selected textured areas,
an extruder positioned adjacent to the pair of rolls to extrude a chosen plastic into the nip region,
a take-out roll situated adjacent to the pair of rolls for extracting from the pair of rolls a sheet of formed plastic reflecting the smooth and textured areas of the at least one pattern roll, and
a cutter for cutting a traffic door panel from the formed plastic sheet.

21. The system of claim 20 wherein the cutter comprises a set of die cutting rolls situated after the takeout roll.

22. The system of claim 20 or 21 further comprising at least one roll of film situated for introduction into the nip region, the at least one film having a color and/or pattern that is integrated into the sheet being formed.

23. The system of claim 22 wherein at least one roll of the film has a width that is less than the width of the formed plastic sheet.

24. The system of claim 22 wherein at least one roll of the film includes a reinforcing element to be included in a textured area of the formed plastic sheet.
